(19) United States
(12) Patent Application Publication
(10) Pub. No.: US 2007/0075122 A1
(43) Pub. Date: Apr. 5, 2007

(54) Method for fabricating a chip module and a device module fabricated therefrom

(76) Inventors: Laurence Edward Singleton, Dresden (DE); Thorsten Meyer, Regensburg (DE); Harry Hedler, Germering (DE)

Correspondence Address: PATTERSON & SHERIDAN, LLP;Gero McClellan / Infineon / Qimonda, 3040 POST OAK BLVD.,, SUITE 1500, HOUSTON, TX, 77056, US

(21) Appl. No.: 11/241,118

(22) Filed: Sep. 30, 2005

(51) Int. Cl. B23K 31/02

(52) U.S. Cl. 228/180.22

(57) ABSTRACT

The present invention relates to a method for fabricating a device module having the steps of providing an integrated device in a Ball Grid Array package wherein the integrated device has a solder contact elevated from a surface of the integrated device, providing a printed circuit board having a contact pad, applying a conductive adhesive on at least one of the solder ball contact and the contact pad, arranging the integrated device on the printed circuit board such that the solder ball contact structure is connected to the contact pad by means of the conductive adhesive.

### BACKGROUND OF THE INVENTION

1. Field of the Invention

The present invention relates to a method for fabricating a chip module. The present invention is further related to a device module including an integrated device which is electrically connected to a printed circuit board.

2. Description of the Related Art

To operate data processing systems with a data storage capacity, usually memory modules are provided which include a number of separated memory devices. A common memory module comprises a printed circuit board on which a number of memory devices are attached. The memory devices usually are in a package such as a ball grid array (BGA) package which is electrically connected to respective contact pads of the printed circuit board. The printed circuit board includes a contact row having a plurality of contacts to interconnect the memory module to the data operating system.

After fabrication, the memory devices are usually tested to ensure their functionality and thereafter applied onto a printed circuit board to form the memory module. Each memory device is usually provided in a ball grid array package having solder balls which are put on respective contact pads of the printed sourced boards and re-flowed so the solder balls form a stable and rigid connection between the contact pads on the printed circuit board and the respective memory device. To reflow the solder balls in the case of lead free solder balls, a high process temperature of about 260° C. is required, which is obviously experienced also by the memory devices on the memory module. This heating can lead to a number of changes in the physical, mechanical and electrical characteristics of the memory device. In particular, the retention time, which is an important electrical feature of memory devices, may be irreparably changed on individual cells by this heating. Such defects can hardly be repaired and often result in a reduced yield of the fabrication of memory modules.

From the document U.S. Pat. No. 6,297,559, it is known to connect a chip device to a printed circuit board by a conductive adhesive, wherein on the printed circuit board a contact structure which is elevated from a surface of the printed board is connected to a contact pad on a surface of the chip device. The contact structure is formed by a contact pad on which a solder ball is attached by means of a solder paste. Thereon, a chip device having merely a contact pad is attached by means of a conductive adhesive. To provide such a contact structure including the solder paste and the solder balls on a printed sourced board is expensive and requires a number of process steps for fabrication which may decrease the overall yield of the fabrication of a device module. Furthermore, a testing of a chip device having merely contact pads instead of contact balls is expensive due to the aligning of the contact pads.

### SUMMARY OF THE INVENTION

One aspect of the present invention provides a method for fabricating a device module wherein an integrated device in a ball grid array package is attached on a printed circuit board in an improved manner in order to increase the overall yield of fabricating a device module. Another aspect of the present invention provides for fabricating a device module wherein the occurrences of defects in a memory device are reduced while assembling a memory module.

Another aspect of the present invention provides a device module which can be assembled in an improved manner which allows for increasing the yield of fabrication.

According to a first aspect of the present invention, a method for fabricating a device module is provided. The method comprises the step of providing an integrated device in a ball grid array package wherein the integrated device has a solder ball contact elevated from a surface of the integrated device; the step of providing a printed circuit board having a contact pad; the step of applying a conductive adhesive on at least one of the solder ball contacts and the contact pad; and the step of arranging the integrated device on the printed circuit board such that the solder ball contact is attached and connected to the contact pad by means of the conductive adhesive.

The method according to one embodiment of the present invention enables a secure connection of a chip device provided as an integrated device having a solder contact which is elevated from a surface of the integrated device to a printed circuit board by means of a conductive adhesive which is applied between the solder contact of the integrated device and the contact pad of the printed circuit board. Carrying out the connection between the integrated device and a printed circuit board using a conductive adhesive has the advantage that a reflow of a solder material can be avoided which is usually carried out by applying reflow temperatures of about 260° C., whereas the maximum temperature for carrying out the adhesive process will be lower. This results in a reduced stress for the integrated device to be applied on the printed circuit board. Additional changes due to temperature-dependent effects on the electrical, physical and mechanical properties of the memory devices will also be reduced.

According to another embodiment of the present invention, the conductive adhesive is hardened and/or cured in a temperature process which is preferably carried out with a maximum temperature of between 150° and 180° C.

The conductive adhesive may beselected to include particles of silver. The conductive adhesive may be further selected to include particles of a low melting point alloy with a melting temperature lower than the melting temperature of the solder contact. In addition, the low melting point alloy has a melting point lower than the temperature required to crosslink the polymer of the conductive adhesive.

According to another aspect of the present invention, a device module is provided which includes an integrated device having a solder contact elevated from a surface of the integrated device, a printed circuit board having a contact pad and an adhesive element by which the solder contact of the integrated device and the contact pad of the printed circuit board are securely attached to each another and electrically interconnected.

According to one embodiment of the present invention, the solder contact is made of a solder material which has a first melting temperature wherein the adhesive element includes particles of a low melting point alloy having a second melting temperature which is lower than the first melting temperature.

Furthermore, the adhesive element may be formed by a hardened conductive adhesive which includes silver particles.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a cross-sectional view through a portion of a device module which shows one interconnection wherein an integrated device is connected to a printed circuit board; and

FIG. 2 shows a preferred embodiment of the present invention in which a TFBGA integrated device is connected to a printed circuit board.

### DETAILED DESCRIPTION OF THE PREFERRED EMBODIMENT

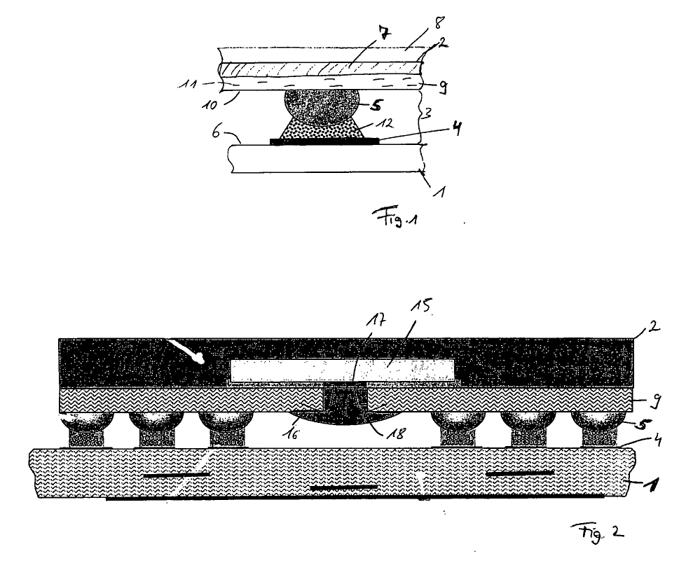

In FIG. 1, a cross-sectional view of a small section of a device module is shown which has a printed circuit board 1 and a chip device 2 which are interconnected by a connecting element 3. The printed circuit board 1 is made of epoxy resin, for example, or another isolating material which may be commonly used for printed circuit boards. The printed circuit board 1 has a size which supports one or more chip devices 2. The printed circuit board 1 comprises a rewiring structure provided on one surface of the printed circuit board 1 and/or within the printed circuit board 1 to electrically connect a contact pad 4 arranged on a surface 6 of the printed circuit board 1 at a predefined location.

The integrated device is formed as a BGA device and includes an integrated circuit chip 7 which is embedded in a package 8 of the chip device 2. The integrated circuit chip 7 is arranged on a substrate 9 on a surface of which a solder contact 5, e.g., a solder ball or solder bump, is rigidly applied. The solder contact 5 is in contact with a rewiring structure which may be located within the substrate 9 and adapted to connect the solder contact 5 with a respective contact port (not shown) of the integrated circuit chip 7. Thus, an integrated circuit included in the integrated circuit chip 7 can be contacted via the solder contact 5. The chip device 2 is placed on the printed circuit board 1 in such a way that the solder contact 5 opposes the contact pad 4 of the printed circuit board 1. Before placing the chip device 2 onto the printed circuit board 1, a conductive adhesive 12 is applied on at least one of the contact pads 4 of the printed circuit board 1 and the solder contact 5 of the chip device 2. The application of the conductive adhesive to the solder contact 5 can be carried out by dipping the solder contact 5 into the conductive adhesive material, by dispensing the adhesive by means of a dispenser or by applying a conductive adhesive material on the plurality of solder contacts of the chip device 2 using a depositing process wherein the areas between the solder contacts 5 can be masked by a deposition mask in order to avoid that the conductive adhesive material is applied in regions between the solder contacts 5.

Many conductive adhesive materials are known in the art, e.g., from the document U.S. Pat. No. 6,344,157 B1 which is incorporated herein by reference. The conductive adhesive material may include particles of silver in a polymeric resin. The particles of silver are preferably non-coated. Furthermore, the polymeric resin may include particles of an alloy, e.g., a solder alloy, having a low melting temperature. The low melting temperature of the alloy has a melting point which is lower than the melting point of the material of the solder contact 5. Instead of the polymeric resin as carrier material for the particles of silver and/or the alloy, other carrier materials may be utilized which have a hardening temperature (curing temperature) at room temperature or at an elevated temperature which is substantially lower than the melting temperature of the solder contact 5. In the case of conventional conductive adhesives, the hardening temperature of the conductive adhesive is between about 150° C. and about 180° C., which is lower than the melting temperature of the solder contact 5 which is at about 260° C. Consequently, the chip device 2 applied on the printed circuit board 1 does not have to be exposed to temperatures required for reflowing the solder contact 5, but only exposed to temperatures which allow an ensured hardening of the conductive adhesive. This reduces the defects in the integrated circuit chip 7 of the chip device 2 due to heating.

The materials of the conductive adhesive and the solder contact have to be adapted to each other. Particularly, the conductive adhesive does not lead to corrosion or oxidation of the solder contacts which may lead to an interaction of the electrical interconnection or at least to a higher contact resistance.

A further advantage is that a chip device which is normally provided in a BGA package having solder balls can be connected to printed circuit boards without applying temperatures which increase the risk of producing defects in the chip devices when they are attached to the module. As the chip devices usually are applied with solder balls, in a Ball Grid Array package, an easier testing of the chip device can be carried out in such a way that the costs for testing the finished chip devices can be kept low in contrast to chip devices having merely contact pads and the like which have to be aligned to and contacted by contact probes of a tester equipment.

In FIG. 2, a cross-sectional view of a portion of the device module is depicted. Same reference numbers indicate elements with the same or similar functionality. The chip device 2 is illustrated as a memory device including a memory chip 15 which is attached to the substrate 9 in a top-side-down arrangement. The substrate 9 includes further contact pads 16 on the same surface on which the solder contacts 5 are applied. The further contact pads 16 are connected to contact areas 17 of the memory chip 15 by means of bond wires 18 to provide an electrical connection to the solder contacts 5. The solder contacts 5 and the further contact pads 16 are in electrical connection by means of a rewiring structure (not shown) in or on the substrate 9. As mentioned above, the solder contacts 5, which may be provided as solder balls, are securely attached to the substrate 9 in a preceding manufacturing process for the chip device 2. The printed circuit board 1 has contact pads 4 which may be formed with the conductor traces thereon. The contact pads 4 are arranged on the surface 6 of the printed circuit board 1 in a mirrored arrangement with respect to the arrangement of the solder contacts 5 on the substrate 9.

The features of the present invention as described above with regard to a specific embodiment can be combined with any of the embodiments described herein.

While the foregoing is directed to embodiments of the present invention, other and further embodiments of the invention may be devised without departing from the basic scope thereof, and the scope thereof is determined by the claims that follow.

What is claimed is:

1. A method for fabricating a device module, comprising;
providing an integrated device in a Ball Grid Array package, wherein the integrated device has a solder ball contact elevated from a surface of the integrated device;
providing a printed circuit board having a contact pad;
applying a conductive adhesive on at least one of the solder ball contact and the contact pad; and
arranging the integrated device on the printed circuit board such that the solder ball contact is connected to the contact pad by the conductive adhesive.

2. The method of claim 1, wherein the conductive adhesive is hardened in a temperature process.

3. The method of claim 2, wherein a maximum temperature of the temperature process is between about 150° C. and about 180° C.

4. The method of claim 1, wherein the conductive adhesive includes particles of silver.

5. The method of claim 4, wherein the conductive adhesive further includes particles of a low melting point alloy with a melting temperature lower than the melting temperature of the solder ball contact.

6. The method of claim 4, wherein the conductive adhesive comprises a polymeric resin in which the particles of silver are disposed.

7. The method of claim 4, wherein the conductive adhesive comprises a carrier material having a curing temperature at room temperature.

8. A device module, comprising:
an integrated device in a Ball Grid Array Package having a solder ball contact elevated from a surface of the integrated device;
a printed circuit board having a contact pad; and
an adhesive element by which the solder ball contact of the integrated device and the contact pad of the printed circuit board are securely attached to one another and electrically interconnected.

9. The device module of claim 8, wherein the solder ball contact comprises a first material having a first melting temperature and wherein the adhesive element includes particles of a second material having a second melting temperature which is lower than the first melting temperature.

10. The device module of claim 9, wherein the second melting temperature is between about 150° C. and about 180° C.

11. The device module of claim 9, wherein the adhesive element is formed by a hardened conductive adhesive comprising silver particles.

12. The device module of claim 11, wherein the conductive adhesive comprises a polymeric resin in which the particles of silver are disposed.

13. The device module of claim 11, wherein the conductive adhesive comprises a carrier material having a curing temperature at room temperature.

14. A method for fabricating a device module, comprising;
forming a plurality of solder ball contacts on a surface of an integrated device;
providing a printed circuit board having a plurality of contact pads corresponding to the plurality of solder ball contacts;
applying a conductive adhesive on at least one of the plurality of solder ball contacts and the plurality of contact pads; and
arranging the integrated device on the printed circuit board, wherein the plurality of solder ball contacts are correspondingly adhered and conductively connected to the plurality of contact pads.

15. The method of claim 14, wherein the conductive adhesive is hardened utilizing an elevated temperature process.

16. The method of claim 15, wherein a maximum temperature of the elevated temperature process is between about 150° C. and about 180° C.

17. The method of claim 14, wherein the conductive adhesive comprises a polymeric resin having particles of silver.

18. The method of claim 14, wherein the conductive adhesive includes particles of a low melting point alloy with a melting temperature lower than the melting temperature of the solder ball contacts.

19. The method of claim 14, wherein the conductive adhesive comprises a carrier material having a curing temperature at room temperature.

20. The method of claim 14, further comprising:
testing the integrated device after forming the solder ball contacts but before applying the conductive adhesive.
